(19) United States
(12) Patent Application Publication
(10) Pub. No.: US 2021/0210978 A1
(43) Pub. Date: Jul. 8, 2021

(54) POWER SUPPLY SYSTEM

(71) Applicant: TOSHIBA MITSUBISHI-ELECTRIC INDUSTRIAL SYSTEMS CORPORATION, Chuo-ku (JP)

(72) Inventors: Kazumasa MATSUOKA, Chuo-ku (JP); Kenta HAYASHI, Chuo-ku (JP)

(73) Assignee: TOSHIBA MITSUBISHI-ELECTRIC INDUSTRIAL SYSTEMS CORPORATION, Chuo-ku (JP)

(21) Appl. No.: 17/056,920

(22) PCT Filed: Nov. 21, 2018
(86) PCT No.: PCT/JP2018/042992

§ 371 Date: Nov. 19, 2020

(51) Int. Cl. H02J 9/06; H02J 7/34

(52) U.S. Cl. CPC H02J 9/068; H02J 2207/20; H02J 9/062; H02J 7/34

(57) ABSTRACT

A power supply system includes AC output converters that are connected in parallel and supply electric power to an AC load. Each of the AC output converters includes an AC-DC converter, a DC-AC converter that converts, a secondary battery, a first switching circuit provided between the AC load and the DC-AC converter, a bypass path, a second switching circuit provided between the AC load and the bypass path, a switch control circuit, and a control power supply circuit. The switch control circuit turns off the first switching circuit upon detection of a decrease in voltage supply from the secondary battery to the AC load during power failure of the external AC voltage, and turns on the second switching circuit upon detection of stop of voltage supply from all of the AC output converters to the AC load during power failure of the external AC voltage.

### TECHNICAL FIELD

The present invention relates to a power supply system for supplying electric power to a load through a parallel connection of a plurality of alternating-current (AC) output converters that perform power conversion from a direct current to an alternating current.

### BACKGROUND ART

A known power supply system supplies electric power to a load through a parallel connection of a plurality of AC output converters, each of which performs power conversion from a direct current to an alternating current.

In this regard, Japanese Patent Laying-Open No. 2017-50933 discloses a power supply system including a plurality of AC output converters, such as inverters, that are connected in series and are operated in parallel to a common load.

### CITATION LIST

### Patent Literature

PTL 1: Japanese Patent Laying-Open No. 2017-50933

### SUMMARY OF INVENTION

### Technical Problem

The power supply system disclosed in PTL 1 is capable of high-efficiency power feeding by supplying electric power from each AC output converter to the load, and in the event of, for example, a power failure, switches to a bypass circuit.

After the power failure, however, the capability of supplying electric power from a storage battery to the load may differ among the AC output converters.

In such a case, when one AC output converter switches to the bypass circuit while a storage battery of another AC output converter continues power feeding, a backflow may occur, leading to a need to switch to the bypass circuit upon completion of power feeding of all AC output converters.

The power supply of one AC output converter, however, does not necessarily operate normally until power feeding of the other AC output converter ends, and switching of the bypass circuit may be difficult.

If the bypass circuit has not been switched normally, the power supply system may not recover normally in restoration of power.

An object of the present invention is to solve the above problem and implement a power supply system capable of safely switching to a bypass circuit in the event of a power failure.

### Solution to Problem

A power supply system according to an aspect includes a plurality of AC output converters that are connected in parallel and supply electric power to an AC load. Each of the plurality of AC output converters includes an AC-direct-current (DC) converter that converts an external AC voltage to a DC voltage, a DC-AC converter that converts the DC voltage to an AC voltage and supplies the AC voltage to the AC load, a secondary battery that is connected in parallel with the DC-AC converter and stores the DC voltage, a first switching circuit provided between the AC load and the DC-AC converter, a bypass path for directly supplying the external AC voltage to the AC load in place of the AC voltage supplied from the DC-AC converter, a second switching circuit provided between the AC load and the bypass path, a switch control circuit that controls the first and second switching circuits during power failure and during restoration of power, and a control power supply circuit for generating a control voltage of the switch control circuit upon receipt of the external AC voltage and the AC voltage. The switch control circuit turns off the first switching circuit upon detection of a decrease in voltage supply from the secondary battery to the AC load during power failure of the external AC voltage, and turns on the second switching circuit upon detection of stop of voltage supply from all of the plurality of AC output converters to the AC load during power failure of the external AC voltage.

Preferably, the switch control circuit turns on the first switching circuit and turns off the second switching circuit during normal operation.

Preferably, the switch control circuit of each of the plurality of AC output converters is connected with the switch control circuit of another AC output converter and receives an input of a signal to stop a voltage from the other AC output converter to the AC load.

### Advantageous Effects of Invention

The power supply system of the present invention can safely switch to a bypass circuit in the event of a power failure.

### BRIEF DESCRIPTION OF DRAWINGS

FIG. 1 illustrates a configuration of an uninterruptible power supply system 1 according to an embodiment.

FIG. 2 illustrates voltage supply of uninterruptible power supply system 1 according to the embodiment during normal operation.

FIG. 3 illustrates voltage supply of a conventional uninterruptible power supply system 1 during power failure.

FIG. 4 illustrates voltage supply of uninterruptible power supply system 1 according to the embodiment during power failure.

FIG. 5 is a flowchart for illustrating an operation of a controller 4 of an AC output converter 10 according to the embodiment during power failure.

### DESCRIPTION OF EMBODIMENTS

An embodiment will now be described with reference to the drawings. This embodiment will describe an uninterruptible power supply system (hereinafter, UPS) as a power supply system by way of example.

The present embodiment will be described using a parallel configuration of a plurality of AC output converters in an uninterruptible power supply system.

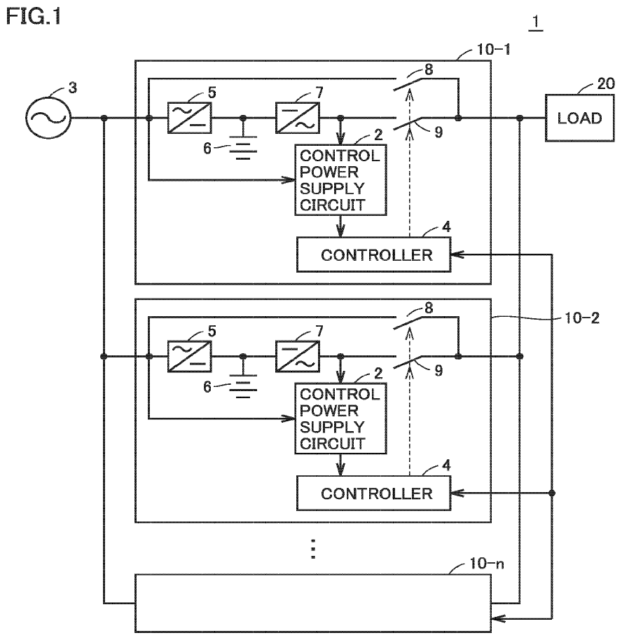

FIG. 1 illustrates a configuration of an uninterruptible power supply system 1 according to an embodiment.

With reference to FIG. 1, uninterruptible power supply system 1 includes a plurality of (n) AC output converters 10-1 to 10-n. AC output converters 10-1 to 10-n (also collectively referred to as AC output converter 10) are connected with an external AC power supply 3 and are operated in parallel to a common load 20. Note that n, which is particularly more than or equal to 2, can be set to any appropriate value in accordance with a load to which electric power is supplied.

A configuration of each AC output converter 10 will be described below.

AC output converter 10 is connected with external AC power supply 3 and includes a converter 5, which converts an AC voltage from external AC power supply 3 to a DC voltage, an inverter 7, which is connected with converter 5 and converts the DC voltage to an AC voltage, and a storage battery 6, which is connected with converter 5 in parallel with inverter 7.

AC output converter 10 further includes a switching circuit 9, which is provided between inverter 7 and the load, a bypass path that is provided separately from a supply path of converter 5 and inverter 7 and supplies an AC voltage, a switching circuit 8, which is provided between the bypass path and the load, a controller 4 (switch control circuit), which controls switching circuits 8 and 9, and a control power supply circuit 2, which generates a driving voltage of controller 4.

Control power supply circuit 2 is connected with the input side of converter 5 and the output side of inverter 7, detects an AC voltage on each side, and generates a driving voltage of controller 4 upon receipt of a supply of the AC voltage. In other words, even in the event of a power failure occurring in external AC power supply 3, control power supply circuit 2 can generate a driving voltage based on an AC voltage supplied from inverter 7. Also, control power supply circuit 2 outputs, to controller 4, a detection signal indicative of a power failure or a decrease in the voltage supplied from inverter 7, in accordance with the AC voltages detected on the output side of inverter 7 and the input side of converter 5.

When external AC power supply 3 stops supplying electric power due to a power failure, electric power is supplied from storage battery 6 to the load.

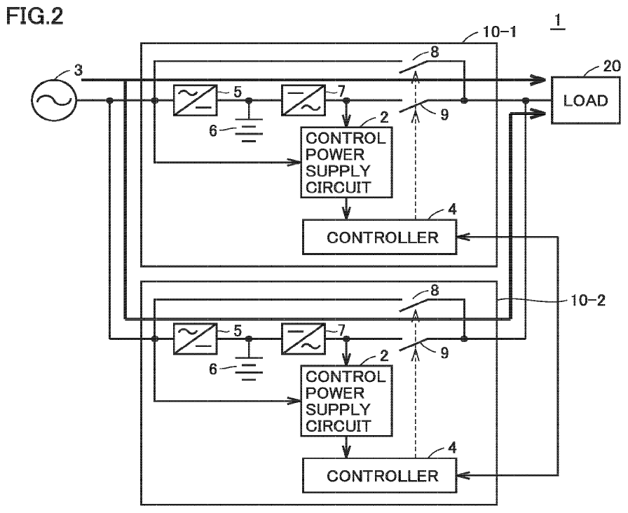

FIG. 2 illustrates voltage supply of uninterruptible power supply system 1 according to the embodiment during normal operation.

A configuration including two AC output converters 10-1 and 10-2 as shown in FIG. 2 will be described by way of example.

During normal operation in which external AC power supply 3 operates normally, switching circuit 9 is turned on with load 20 and inverter 7 being connected.

Converter 5 converts the AC voltage from external AC power supply 3 to a DC voltage. Inverter 7 is connected with converter 5 and converts the DC voltage to an AC voltage. Storage battery 6 stores the DC voltage converted by converter 5.

Electric power is supplied from inverter 7 through switching circuit 9 to load 20.

Since AC output converters 10 have a parallel configuration, required electric power is supplied from each AC output converter 10 to load 20.

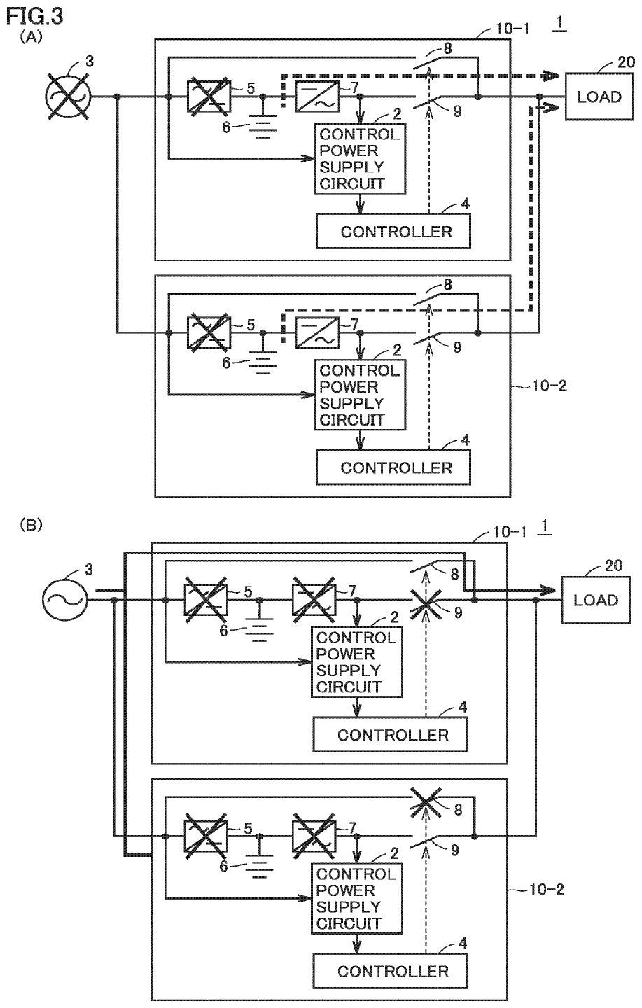

FIG. 3 illustrates voltage supply of a conventional uninterruptible power supply system 1 during power failure.

A configuration including two AC output converters 10-1 and 10-2 as shown in FIG. 3(A) will be described by way of example.

A case in which external AC power supply 3 has a power failure will be described. In this case, since the voltage supply from converter 5 decreases, supply of electric power from storage battery 6 through inverter 7 and switching circuit 9 to load 20 is continued. In this state, switching circuit 8 is turned off.

During normal operation in which an operation is performed, switching circuit 9 is turned on with load 20 and inverter 7 being connected to each other.

Converter 5 converts the AC voltage from external AC power supply 3 to a DC voltage. Inverter 7 is connected with converter 5 and converts the DC voltage to an AC voltage. Storage battery 6 stores the DC voltage converted by converter 5.

Electric power is supplied from inverter 7 through switching circuit 9 to load 20.

Since AC output converters 10 have a parallel configuration, required electric power is supplied from each AC output converter 10 to load 20.

The following will describe a case in which, for example, storage battery 6 of AC output converter 10-1 and storage battery 6 of AC output converter 10-2 differ from each other in the capability of supplying electric power.

This example will describe a case in which storage battery 6 of AC output converter 10-1 has the above capability higher than that of storage battery 6 of AC output converter 10-2.

In this case, when supply from AC output converter 10-1 to load 20 is continued even though supply from storage battery 6 of AC output converter 10-2 to load 20 is stopped, a backflow may occur, and accordingly, switching circuit 8 of AC output converter 10-2 cannot be turned on.

Thus, AC output converter 10-2 needs to wait for an instruction to switch from switching circuit 9 to switching circuit 8 until supply from AC output converter 10-1 to load 20 ends.

During a waiting period, control power supply circuit 2 needs to continuously secure the driving voltage of controller 4. When the waiting period is long, however, control power supply circuit 2 may have difficulty in securing the driving voltage of controller 4. If control power supply circuit 2 can no longer secure the driving voltage of controller 4, an instruction to switch from switching circuit 9 to switching circuit 8 cannot be output, so that switching circuit 8 keeps the off state.

FIG. 3(B) shows a case in which restoration of power occurs with switching circuit 9 of AC output converter 10-1 being turned on and switching circuit 8 of AC output converter 10-2 being turned off.

In this case, since switching circuit 8 of AC output converter 10-1 is turned on, electric power is supplied to load 20 through the bypass path.

On the other hand, switching circuit 8 of AC output converter 10-2 is turned off, electric power cannot be supplied to load 20 through the bypass path.

Thus, load 20 is supplied with electric power only by AC output converter 10-1, leading to an overload state. Consequently, supply from AC output converter 10-1 is also stopped.

In other words, the conventional uninterruptible power supply system may fail to perform a normal power restoration process.

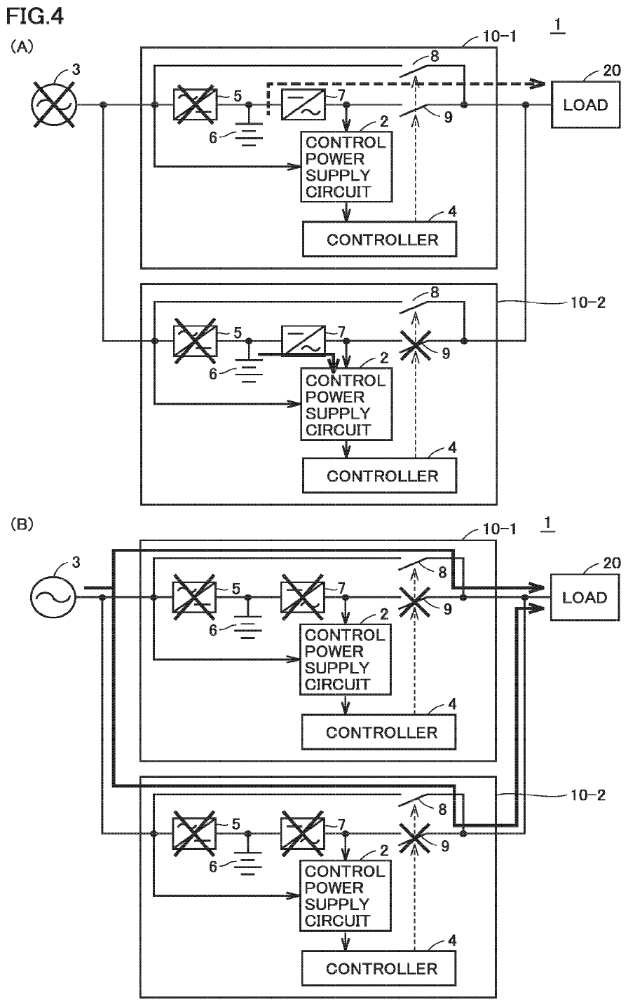

FIG. 4 illustrates voltage supply of uninterruptible power supply system 1 according to the embodiment during power failure.

A configuration including two AC output converters 10-1 and 10-2 as shown in FIG. 4(A) will be described by way of example.

A case in which external AC power supply 3 has a power failure will be described.

In this case, since voltage supply from converter 5 decreases, supply of electric power from storage battery 6 through inverter 7 and switching circuit 9 to load 20 is continued. In this state, switching circuit 8 is turned off.

The following will describe a case in which, for example, storage battery 6 of AC output converter 10-1 and storage battery 6 of AC output converter 10-2 are different from each other in the capability of supplying electric power, as described above.

This example will describe a case in which storage battery 6 of AC output converter 10-1 has the above capability higher than that of storage battery 6 of AC output converter 10-2.

As described above, when supply from AC output converter 10-1 to load 20 is continued even though supply from storage battery 6 of AC output converter 10-2 to load 20 is stopped, a backflow may occur, and accordingly, switching circuit 8 of AC output converter 10-2 cannot be turned on.

Thus, when detecting that voltage supply from storage battery 6 of AC output converter 10-2 to load 20 has decreased, controller 4 according to the embodiment turns off switching circuit 9 of AC output converter 10-2. Controller 4 also notifies controller 4 of AC output converter 10-1 that it has turned off switching circuit 9 due to the decrease in voltage supply.

Inverter 7 receives a supply of the DC voltage from storage battery 6 and continues supplying the driving voltage of controller 4.

When the supply from AC output converter 10-1 to load 20 ends, then, controllers 4 of AC output converters 10-1 and 10-2 perform setting to turn on switching circuit 8 and turn off switching circuit 9.

Specifically, controller 4 of AC output converter 10-1 notifies controller 4 of AC output converter 10-2 that it has turned off switching circuit 9 due to a decrease in voltage supply.

Upon receipt of the notification indicating that switching circuit 9 has been turned off from controller 4 of AC output converter 10-1, controller 4 of AC output converter 10-2 detects that all of AC output converters 10 have stopped supplying a voltage to load 20, and then turns on switching circuit 8.

The same applies to controller 4 of AC output converter 10-1, which detects a decrease in the voltage supply from storage battery 6 of AC output converter 10-1 to load 20, and upon receipt of the notification indicating that switching circuit 9 has been turned off from controller 4 of AC output converter 10-2, detects that all AC output converters 10 have stopped supplying a voltage to load 20, and then turns on switching circuit 8.

FIG. 4(B) shows a case in which power is restored with switching circuits 8 of AC output converters 10-1 and 10-2 being turned on.

In this case, since switching circuits 8 of AC output converters 10-1 and 10-2 are turned on, electric power is supplied to load 20 through the bypass path.

Consequently, electric power is supplied to load 20 from AC output converters 10-1 and 10-2, thus restraining an overload state, which allows a restoration process to be performed normally. In other words, uninterruptible power supply system 1 according to the embodiment can perform a normal power restoration process.

Although this example has mainly described two AC output converters 10, the present invention is not limited thereto. This example is also applicable to a case of three or more AC output converters 10.

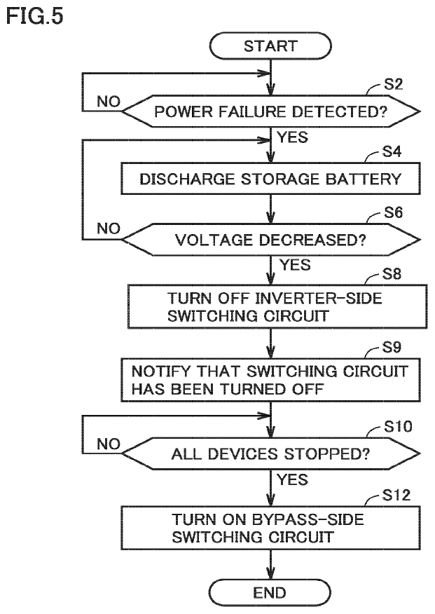

FIG. 5 is a flowchart illustrating an operation during a power failure of controller 4 of AC output converter 10 according to the embodiment.

Referring to FIG. 5, controller 4 determines whether it has detected a power failure (step S2). Since control power supply circuit 2 is connected to the input side of converter 5, control power supply circuit 2 detects a power failure of external AC power supply 3. Control power supply circuit 2 notifies controller 4 of the power failure. Control power supply circuit 2 also generates a driving voltage of controller 4 based on the AC voltage output from inverter 7 and then outputs the driving voltage.

When detecting a power failure at step S2 (YES at step S2), controller 4 starts discharging the storage battery (step S4). When accepting a notification about the power failure from control power supply circuit 2, controller 4 stops the operation of converter 5. Then, supply from storage battery 6 to load 20 is started.

Controller 4 then determines whether the voltage discharged from the storage battery begins to decrease (step S6). Since control power supply circuit 2 is connected to the output side of inverter 7, control power supply circuit 2 detects a decrease in the voltage supplied from inverter 7 and notifies controller 4 of the decrease. Controller 4 determines a decrease in the voltage discharged from the storage battery in accordance with the notification.

When the voltage discharged from the storage battery begins to decrease at step S6 (YES at step S6), controller 4 turns off switching circuit 9 on the inverter side (step S8). Controller 4 turns off switching circuit 9 in accordance with the notification from control power supply circuit 2.

Controller 4 then notifies that switching circuit 9 has been turned off (step S9). Controller 4 notifies controller 4 of another AC output converter 10 that switching circuit 9 has been turned off.

Controller 4 then determines whether all the devices have been stopped (step S10). Controller 4 determines whether it has received a signal for notifying that switching circuit 9 of another AC output converter 10 has been turned off from all the devices.

When determining at step S10 that all the devices have been stopped (YES at step S10), controller 4 turns on switching circuit 8 on the bypass side (step S12).

When determining at step S10 that all the devices have not been stopped (NO at step S10), controller 4 maintains the state of step S10.

Then, the process ends (END).

For the above configuration, the description has been given of an approach in which control power supply circuit 2 is connected to the input side of converter 5 and the output side of inverter 7, detects the AC voltages on the respective sides, and notifies controller 4 of a power failure or a decrease in the voltage supplied from inverter 7. Another approach may be applied in which voltage is detected with another sensor in place of control power supply circuit 2 and a notification is provided to controller 4. Alternatively, controller 4 may be directly connected to the input side of converter 5 and the output side of inverter 7, detect the AC voltages on the respective sides, detect a power failure or a decrease in the voltage supplied from inverter 7.

Although the embodiment of the present invention has been described above, it should be construed that the embodiment disclosed herein is given by way of illustration in all respects, not by way of limitation. The scope of the present invention is defined by the terms of the claims, and is intended to include any modifications within the scope and meaning equivalent to the terms of the claims.

### REFERENCE SIGNS LIST

1 uninterruptible power supply system, 2 control power supply circuit, 3 external AC power supply, 4 controller, 5 converter, 6 storage battery, 7 inverter, 8, 9 switching circuit, 10 AC output converter, 20 load.

1. A power supply system comprising a plurality of AC output converters that are connected in parallel and supply electric power to an AC load, wherein
each of the plurality of AC output converters includes
an AC-DC converter that converts an external AC voltage to a DC voltage,
a DC-AC converter that converts the DC voltage to an AC voltage and supplies the AC voltage to the AC load,
a secondary battery that is connected in parallel with the DC-AC converter and stores the DC voltage,
a first switching circuit provided between the AC load and the DC-AC converter,
a bypass path for directly supplying the external AC voltage to the AC load in place of the AC voltage supplied from the DC-AC converter,
a second switching circuit provided between the AC load and the bypass path,
a switch control circuit that controls the first and second switching circuits during power failure and during restoration of power, and
a control power supply circuit for generating a control voltage of the switch control circuit upon receipt of the external AC voltage and the AC voltage, and
the switch control circuit
turns off the first switching circuit upon detection of a decrease in voltage supply from the secondary battery to the AC load during power failure of the external AC voltage, and
turns on the second switching circuit upon detection of stop of voltage supply from all of the plurality of AC output converters to the AC load during power failure of the external AC voltage.

2. The power supply system according to claim 1, wherein the switch control circuit turns on the first switching circuit and turns off the second switching circuit during normal operation.

3. The power supply system according to claim 1, wherein the switch control circuit of each of the plurality of AC output converters is connected with the switch control circuit of another AC output converter and receives an input of a signal to stop a voltage from the other AC output converter to the AC load.
